(19) United States
(12) Patent Application Publication
(10) Pub. No.: US 2025/0220574 A1
(43) Pub. Date: Jul. 3, 2025

(54) METHOD AND APPARATUS FOR CONFIGURING WAKE UP SIGNAL CONFIGURATION INFORMATION, METHOD AND APPARATUS FOR RECEIVING WAKE UP SIGNAL CONFIGURATION INFORMATION, NETWORK DEVICE, UE, AND STORAGE MEDIUM

(71) Applicant: Beijing Xiaomi Mobile Software Co., Ltd., Beijing (CN)

(72) Inventor: Ting FU, Beijing (CN)

(73) Assignee: Beijing Xiaomi Mobile Software Co., Ltd., Beijing (CN)

(21) Appl. No.: 18/849,613

(22) PCT Filed: Mar. 31, 2022
(86) PCT No.: PCT/CN2022/084699

§ 371 Date: Sep. 23, 2024

(51) Int. Cl. H04W 52/02

(52) U.S. Cl. CPC H04W 52/0212; H04W 52/0235

(57) ABSTRACT

The present disclosure provides a method and apparatus for configuring wake up signal configuration information, a method and apparatus for receiving wake up signal configuration. information, a user equipment (UE), and a storage medium. The method for configuring wake up signal configuration information comprises: configuring wake up signal configuration region IDs, wherein network devices having the same wake up signal configuration region ID have the same wake up signal configuration.

### CROSS-REFERENCE TO RELATED APPLICATIONS

The present application is a National Phase application of International Application No. PCT/CN2022/084699, filed on Mar. 31, 2022, the entire contents of which are incorporated herein by reference.

### TECHNICAL FIELD

The present disclosure relates to the technology for configuring wake-up signal configuration information, and more particularly to a method and apparatus for configuring and receiving wake-up signal configuration information, a network device, a user equipment (UE), and a storage medium.

### BACKGROUND

In R18, a low-power wake-up signal (LP WUS) is introduced. The User Equipment (UE) uses a Low Power (LP) receiver to receive the LP WUS. The UE needs to use the main transceiver to normally process downlink and uplink data. If the UE receives the LP WUS indicating wake up, it will turn on the main receiver to receive and process the downlink signal. If it does not receive the wake-up signal (WUS) signal, or the WUS indicates not to wake up, the UE will keep the main receiver in dormant state.

At present, the configuration information of LP WUS is sent through system messages.

It should be noted that, information disclosed in the above background portion is provided only for better understanding of the background of the present disclosure, and thus it may contain information that does not form the prior art known by those ordinary skilled in the art.

### SUMMARY

In view of this, embodiments of the present disclosure provide a method and apparatus for configuring and receiving wake-up signal configuration information, a network device, a user equipment, and a storage medium.

According to a first aspect of the present disclosure, a method for configuring wake-up signal configuration information is provided, which is applied to a network device, and the method includes:
configuring a wake-up signal configuration area identifier ID, wherein network devices having the same wake-up signal configuration area ID have the same wake-up signal configuration.

In some exemplary embodiments, the method further includes:
sending the wake-up signal configuration area ID to a user equipment UE.

According to a second aspect of the present disclosure, a method for receiving wake-up signal configuration information is provided, which is applied to a user equipment, wherein the method includes:
receiving a wake-up signal configuration area identifier ID sent from a network device, wherein network devices having the same wake-up signal configuration area ID have the same wake-up signal configuration.

According to a third aspect of the present disclosure, an apparatus for configuring wake-up signal configuration information is provided, which is applied to a network device, wherein the apparatus includes:
a configuring unit, configured to configure a wake-up signal configuration area identifier ID, wherein network devices having the same wake-up signal configuration area ID have the same wake-up signal configuration.

According to a fourth aspect of the present disclosure, a network device is provided, which includes a processor, a memory, and an executable program stored in the memory and capable of being run by the processor, wherein the processor is configured to execute steps of the method for configuring wake-up signal configuration information according to the first aspect when running the executable program.

According to a fifth aspect of the present disclosure, a user equipment is provided, which includes a processor, a memory and an executable program stored in the memory and capable of being run by the processor, wherein the processor is configured to execute steps of the method for receiving wake-up signal configuration information according to the second aspect when running the executable program.

According to a sixth aspect of the present disclosure, a storage medium having an executable program stored thereon is provided, wherein when the executable program is executed by a processor, steps of the method for configuring wake-up signal configuration information according to the first or second aspect are implemented.

It is to be understood that both the foregoing general description and the following detailed description are exemplary and explanatory only and are not restrictive of the present disclosure.

### BRIEF DESCRIPTION OF THE DRAWINGS

The accompanying drawings, which are incorporated in and constitute a part of this specification, illustrate embodiments consistent with the present invention and, together with the description, serve to explain the principles of the embodiments of the present invention.

FIG. 1 is a schematic structural diagram of a wireless communication system according to an exemplary embodiment;

FIG. 2 is a schematic flow chart of a method for configuring wake-up signal configuration information according to an exemplary embodiment;

FIG. 3 is a schematic flow chart of a method for configuring wake-up signal configuration information according to an exemplary embodiment;

FIG. 4 is a schematic flow chart of a method for configuring wake-up signal configuration information according to an exemplary embodiment;

FIG. 5 is a diagram showing a method for receiving wake-up signal configuration information according to an exemplary embodiment;

FIG. 6 is a diagram showing a method for receiving wake-up signal configuration information according to an exemplary embodiment;

FIG. 7 is a schematic diagram showing a structure of an apparatus for configuring wake-up signal configuration information according to an exemplary embodiment;

FIG. 8 is a schematic diagram showing a structure of an apparatus for receiving wake-up signal configuration information according to an exemplary embodiment;

FIG. 9 is a structural diagram showing a structure of a user equipment according to an exemplary embodiment.

### DETAILED DESCRIPTION

Exemplary embodiments will be described in detail herein, examples of which are shown in the accompanying drawings. When the following description refers to the drawings, the same numbers in different drawings represent the same or similar elements unless otherwise indicated. The implementations described in the following exemplary embodiments do not represent all implementations consistent with the embodiments of the present disclosure. Instead, they are merely examples of devices and methods consistent with some aspects of the embodiments of the present disclosure as detailed in the appended claims.

The terms used in the disclosed embodiments are only for the purpose of describing specific embodiments and are not intended to limit the disclosed embodiments. The singular forms of “a”, “said” and “the” used in the disclosed embodiments and the appended claims are also intended to include plural forms unless the context clearly indicates other meanings. It should also be understood that the term “and/or” used herein refers to and includes any or all possible combinations of one or more associated listed items.

It should be understood that although the terms first, second, third, etc. may be used to describe various information in the disclosed embodiments, such information should not be limited to these terms. These terms are only used to distinguish the same type of information from each other. For example, without departing from the scope of the disclosed embodiments, the first information may also be referred to as the second information, and similarly, the second information may also be referred to as the first information. Depending on the context, the word “if” as used herein may be interpreted as “at the time of” or “when” or “in response to determining”.

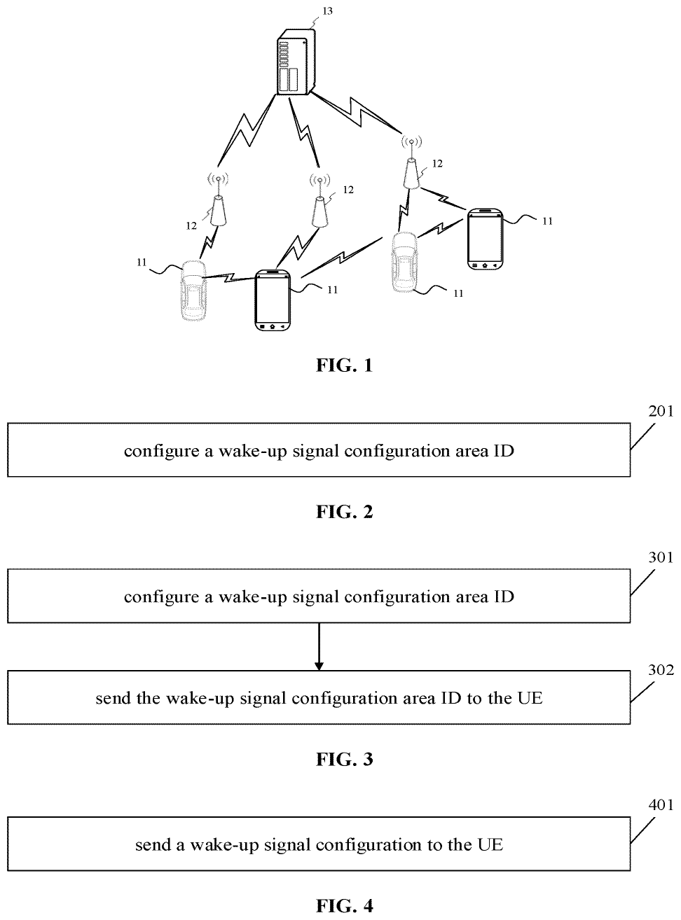

Please refer to FIG. 1, which shows a schematic diagram of the structure of a wireless communication system provided by an embodiment of the present disclosure. As shown in FIG. 1, the wireless communication system is a communication system based on cellular mobile communication technology, and the wireless communication system may include: a plurality of user equipments 11 and a plurality of base stations 12.

In the embodiment, the user equipment 11 can be a device that provides voice and/or data connectivity to the user. The user equipment 11 can communicate with one or more core networks via a radio access network (RAN). The user equipment 11 can be an Internet of

Things terminal, such as a sensor device, a mobile phone (or a “cellular” phone) and a computer with an Internet of Things terminal. For example, it can be a fixed, portable, pocket-sized, handheld, computer-built-in or vehicle-mounted device. For example, a station (STA), a subscriber unit, a subscriber station, a mobile station, a mobile, a remote station, an access point, a remote terminal, an access terminal, a user terminal, a user agent, a user device, or a user equipment (UE). Alternatively, the user equipment 11 can also be a device of an unmanned aerial vehicle. Alternatively, the user equipment 11 can also be a vehicle-mounted device, for example, it can be a driving computer with wireless communication function, or a wireless communication device connected to an external driving computer. Alternatively, the user equipment Il may also be a roadside device, for example, a street lamp, a signal lamp or other roadside device with a wireless communication function.

The base station 12 may be a network-side device in a wireless communication system. The wireless communication system may be a fourth generation mobile communication technology (4G) system, also known as a long term evolution (LTE) system; or, the wireless communication system may be a 5G system, also known as a new radio (NR) system or a 5G NR system. Alternatively, the wireless communication system may be any generation system. The access network in the 5G system may be referred to as a NG-RAN (New Generation-Radio Access Network). Alternatively, an MTC system.

The base station 12 may be an evolved base station (eNB) used in a 4G system. Alternatively, the base station 12 may also be a base station (gNB) using a centralized distributed architecture in a 5G system. When the base station 12 uses a centralized distributed architecture, it generally includes a central unit (CU) and at least two distributed units (DU). The central unit is provided with protocol stacks of a packet data convergence protocol (PDCP) layer, a radio link layer control protocol (RLC) layer, and a media access control (MAC) layer; and the distributed unit is provided with a physical (PHY) layer protocol stack. The embodiments of the present disclosure do not limit the specific implementation of the base station 12.

A wireless connection can be established between the base station 12 and the user equipment 11 through a wireless air interface. In different implementations, the wireless air interface is a wireless air interface based on the fourth generation mobile communication network technology (4G) standard; or, the wireless air interface is a wireless air interface based on the fifth generation mobile communication network technology (5G) standard, for example, the wireless air interface is a new air interface; or, the wireless air interface can also be a wireless air interface of a next generation mobile communication network technology standard after 5G.

In some embodiments, an E2E (End to End) connection may also be established between user devices 11, such as V2V (vehicle to vehicle) communication, V2I (vehicle to Infrastructure) communication, and V2P (vehicle to Pedestrian) communication in vehicle-to-everything (V2X) communication.

In some embodiments, the wireless communication system may further include a network management device 13.

The execution subjects involved in the embodiments of the present disclosure include, but are not limited to: user equipment (UE) in a cellular mobile communication system, and a base station of a cellular mobile communication system, or the like.

FIG. 2 is a flow chart of a method for configuring wake-up signal configuration information according to an exemplary embodiment. As shown in FIG. 2, the method for configuring wake-up signal configuration information according to an exemplary embodiment of the present disclosure can be applied to a network device, and specifically includes the following processing steps.

Step 201: configure a wake-up signal configuration area ID, wherein the wake-up signal configurations configured for network devices having the same wake-up signal configuration area ID are the same.

The method for configuring wake-up signal configuration information provided by the embodiment of the present disclosure can be executed by any UE including a first transceiver and a second transceiver.

The UE can be various types of terminal devices, including but not limited to: mobile phones, tablet computers, wearable devices, Internet of Things devices, smart home devices and/or smart office devices.

The UE includes a first transceiver and a second transceiver, that is, the UE has at least two transceivers.

In some embodiments, the second transceiver may be a receiver having a receiving function only.

In some other embodiments, the second transceiver may be a transceiver having both a transmitting function and a receiving function.

In one embodiment, the power consumption of the first transceiver when in the on state is greater than the power consumption of the second transceiver when in the on state. In some embodiments, the second transceiver may be a low power transceiver.

In some embodiments, the second transceiver is a transceiver capable of monitoring the power saving signal. For example, the second transceiver may be a transceiver monitoring the LP WUS.

In another embodiment, the transceiver capability of the first transceiver is stronger than that of the second transceiver. Exemplarily, the first transceiver can receive and decode non-access stratum (NAS) messages, RRCS messages, MAC layer messages and/or DCI, etc., while the second transceiver can only receive physical layer signals.

Normally, the first transceiver of the UE remains turned on, but the UE will turn off the first transceiver if certain conditions are met. The certain conditions may include but are not limited to: the UE does not transmit service data within a preset period of time, or receives a user instruction to turn off the first transceiver, etc. This is just an example of the first transceiver entering the off state (i.e., the first transceiver is turned off), and the specific implementation is not limited to the above example.

In the disclosed embodiment, when there is no service in the user equipment for a long time for a long time, in order to save power, the first transceiver, i.e., the main receiver, of the user equipment is in a dormant state, and the user equipment starts the second transceiver, i.e., the WUS LP receiver, and monitors the WUS at the WUS timing corresponding to the UE in the WUS cycle according to the wake-up signal configuration of the network device. However, the configuration information of the WUS is sent through the system message of the network device. If the WUS configurations of different cells are different, for example, the WUS cycles are different, or the WUS timing configurations in a cycle are different, then, for the user equipment with the main receiver turned off and only the LP receiver turned on, when it is moved from one cell to another, if the LP WUS configuration of the new cell is different from that of the original cell, and the user equipment does not know the LP WUS configuration of the new cell, then the LP receiver of the user equipment can no longer monitor the LP WUS signal of the new cell.

Therefore, in response to this situation, the embodiment of the present disclosure configures a corresponding identifier ID for the wake-up signal configuration area on the basis of the WUS configuration, and notifies the UE of the configured wake-up signal configuration area ID, so that the UE can determine the wake-up signal configuration status in the cell based on the wake-up signal configuration area ID.

In the embodiment of the present disclosure, the configured wake-up signal configurations of the network devices having the same wake-up signal configuration area ID are the same.

In the disclosed embodiment, the network device configures the wake-up signal configuration information in units of one area. All cells contained in one area have the same wake-up signal configuration. The area is the wake-up signal configuration area. When the user equipment moves from the original cell to the new cell within the wake-up signal configuration area, the user equipment does not need to turn on the main receiver to receive the wake-up signal configuration of the new cell, and can directly monitor the wake-up signal according to the wake-up signal configuration of the original cell.

In the embodiment of the present disclosure, the wake-up signal carries a wake-up signal configuration area ID, and the wake-up signal configuration area identifier includes but is not limited to: an area number and/or an area name, etc. The area identifier indicates the area where the base station or cell sending the wake-up signal is located.

In some embodiments, for example, within the same area, if the wake-up signal configuration changes, the signal configuration area ID within the area may also change.

FIG. 3 is a flow chart of a method for configuring wake-up signal configuration information according to an exemplary embodiment. As shown in FIG. 3, the method for configuring wake-up signal configuration information according to an exemplary embodiment of the present disclosure can be applied to a network device, and specifically includes the following processing steps:

Step 301: configure a wake-up signal configuration area ID, wherein the wake-up signal configurations configured on network devices having the same wake-up signal configuration area ID are the same.

In the disclosed embodiment, when there is no service in the user equipment for a long time for a long time, in order to save power, the main receiver of the user equipment is in a dormant state, and the user equipment starts the LP receiver, and monitors the WUS at the WUS timing corresponding to the UE in the WUS cycle according to the wake-up signal configuration of the network device. However, the configuration information of the WUS is sent through the system message of the network device. If the WUS configurations of different cells are different, for example, the WUS cycles are different, or the WUS timing configurations in a cycle are different, then, for the user equipment with the main receiver turned off and only the LP receiver turned on, when it is moved from one cell to another, if the LP WUS configuration of the new cell is different from that of the original cell, and the user equipment does not know the LP WUS configuration of the new cell, then the LP receiver of the user equipment can no longer monitor the LP WUS signal of the new cell.

Therefore, in response to this situation, the embodiment of the present disclosure configures a corresponding identifier ID for the wake-up signal configuration area on the basis of the WUS configuration, and notifies the UE of the configured wake-up signal configuration area ID, so that the UE can determine the wake-up signal configuration status in the cell based on the wake-up signal configuration area ID.

In the embodiment of the present disclosure, the configured wake-up signal configurations of the network devices having the same wake-up signal configuration area ID are the same.

As an example, the network device broadcasts a wake-up signal, and the wake-up signal includes the wake-up signal configuration area ID configured by the network device. The user equipment determines whether the wake-up signal configuration area ID of the network device to which the new mobile cell belongs is the same as the wake-up signal configuration area ID of the network device to which the original cell belongs based on the wake-up signal configuration area ID included in the wake-up signal. As an example, the user equipment may also determine whether the wake-up signal configuration area ID of the network device to which the new cell belongs is the same as that of the original cell based on whether the broadcast signal (such as the wake-up signal) is the same.

In the embodiment of the present disclosure, the network device may be a base station. As an example, the network device may also be a related network element on the core network side, which configures the wake-up signal configuration area ID and notifies the UE of the configured wake-up signal configuration area ID through the base station.

In the disclosed embodiment, the network device configures the wake-up signal in units of one area. All cells contained in one area have the same wake-up signal configuration. The area is the wake-up signal configuration area. When the user equipment moves from the original cell to the new cell within the wake-up signal configuration area, the user equipment does not need to turn on the main receiver to receive the wake-up signal configuration of the new cell, and can directly monitor the wake-up signal according to the wake-up signal configuration of the original cell.

Step 302: send the wake-up signal configuration area ID to the UE.

In the embodiment of the present disclosure, the wake-up signal configuration area ID is broadcast through a system message. At the same time, the network device broadcasts the wake-up signal through a broadcast signal such as a wake-up signal; that is, the network device sends the wake-up signal configuration area ID to the UE through a system broadcast, and the UE obtains the wake-up signal configuration area ID by monitoring the system message of the network device. At the same time, when the main receiver is in the dormant state, when the user equipment moves to a cell, it can be determined whether the wake-up signal configuration in the new cell has changed by whether the wake-up signal is the same as the original cell and whether the wake-up signal configuration area ID obtained through the wake-up signal is the same.

FIG. 4 is a flow chart of a method for configuring wake-up signal configuration information according to an exemplary embodiment. As shown in FIG. 4, the method for configuring wake-up signal configuration information according to an exemplary embodiment of the present disclosure can be applied to a network device, and specifically includes the following processing steps:

Step 401: send a wake-up signal configuration to the UE.

In the embodiment of the present disclosure, the wake-up signal configuration is sent to the UE through a system message, that is, the wake-up signal configuration is carried in a system message and sent to the UE.

The wake-up signal configuration includes at least one of the following;
a wake-up signal cycle;
a frequency domain location of the wake-up signal;
a time domain offset of the wake-up signal relative to a reference time;
a number of wake-up signal occasions in one wake-up signal cycle;
a time domain position distribution of the wake-up signal timing in a wake-up signal cycle; and
a wake-up signal sequence corresponding to the UE group.

In some implementations, one UE group corresponds to one WUS sequence. As an implementation, the code domains of different WUS sequences of the UE group may be orthogonal, that is, code-divided. As an implementation, the WUS sequence of the UE group may be a bit array, and different UE groups are marked by cyclic shift. The WUS sequence of the UE group may also be a hash value of identification information of a set component of the UE in the UE group, such as a chip.

In the embodiment, the number of WUS occasions in a WUS cycle is linearly related to the size of the WUS cycle. Specifically, the number of WUS occasions in a WUS cycle is configured as N=X×T, wherein T is the size of the WUS cycle, for example, the cycle T is in units of radio frames. T is 128, 256, etc.; X is a linearly related parameter, and X is less than or equal to 1. As an example, X is 1, 0.5, 0.25, 0.2, 0.125, etc.

In one embodiment, the period of the wake-up signal may be configured by the network device or agreed upon by the protocol. For example, the period of the wake-up signal may be 160 ms, 320 ms, 640 ms, or 1280 ms. These values are only examples, and the period of the wake-up signal is not limited to the above examples.

The transmission duration of a single wake-up signal may be in the order of symbols, for example, a single wake-up signal transmission may occupy one or more symbols. Exemplarily, the duration occupied by a single wake-up signal may be less than or equal to one time slot.

If the cell where the UE is located uses beam communication, the wake-up signal configuration may also include: the time domain offset of the wake-up signal transmitted by different beams within the transmission cycle of a wake-up signal. The time domain offset is at least greater than the duration occupied by a single transmission of the wake-up signal. For example, if the single transmission of the wake-up signal occupies Z symbols, the time domain offset of the wake-up signal transmitted by different beams within the transmission cycle of a wake-up signal is equal to or greater than Z symbols.

In the embodiment of the present disclosure, the network device may be a base station. As an example, the network device may also be a related network element on the core network side, which configures the wake-up signal configuration area ID and notifies the UE of the configured wake-up signal configuration area ID through the base station.

In the disclosed embodiment, the same LP WUS configuration can be configured for multiple cells. That is, in these multiple cells, the WUS cycle broadcast by the base station, the number of WUS occasions included in the WUS cycle, and the time-frequency domain position of the WUS occasion corresponding to the UE are all the same. In this way, when the UE moves from one cell to another among the multiple cells, as long as the wake-up signal configuration area ID of the new cell is the same as the wake-up signal configuration area ID of the cell before the move, the UE can still continue to use the LP receiver to receive the LP WUS signal, without turning on the main receiver to receive the system message to obtain the WUS configuration information of the new cell. This saves more power for the UE.

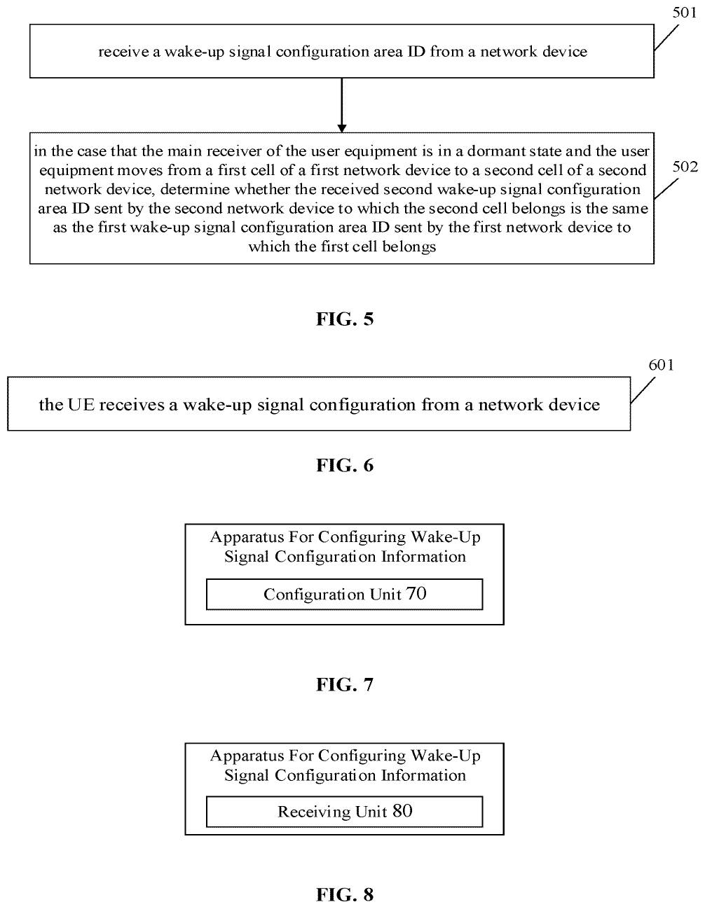

FIG. 5 is a flow chart of a method for receiving wake-up signal configuration information according to an exemplary embodiment. As shown in FIG. 5, the method for receiving wake-up signal configuration information according to an exemplary embodiment of the present disclosure may be applied to a user equipment, and specifically includes the following processing steps:

Step 501: receive a wake-up signal configuration area ID from a network device.

When the UE obtains the wake-up signal configuration by monitoring the system message of the network device, it also monitors the wake-up signal configuration area ID.

As an implementation method, the UE can also receive the wake-up signal configuration area ID through the broadcast signal of the network device, such as the wake-up signal, so that the UE in the dormant state can determine whether the wake-up signal configuration of the new cell is the same based on whether the wake-up signal configuration area ID is the same as the original cell.

Step 502, in the case that the main receiver of the user equipment is in a dormant state and the user equipment moves from a first cell of a first network device to a second cell of a second network device, determine whether the received second wake-up signal configuration area ID sent by the second network device to which the second cell belongs is the same as the first wake-up signal configuration area ID sent by the first network device to which the first cell belongs.

In the embodiment of the present disclosure, when the first wake-up signal configuration area ID is the same as the second wake-up signal configuration area ID, the wake-up signal configuration of the first cell is maintained; and
when the first wake-up signal configuration area ID is different from the second wake-up signal configuration area ID, the main receiver is woken up to receive the system message of the second network device and obtain the wake-up signal configuration of the second cell.

The UE obtains the second wake-up signal configuration area ID of the second cell by monitoring the system message or the second wake-up signal of the second cell.

In the embodiment of the present disclosure, when the main receiver of the user equipment is turned off, the user equipment receives the broadcast signal broadcast by the network device through the LP receiver. As an example, the user equipment receives the wake-up signal broadcast by the network device through the LP receiver, and the wake-up signal includes the wake-up signal configuration area ID configured by the base station. The user equipment determines whether the wake-up signal configuration area ID of the network device to which the second cell belongs is the same as the wake-up signal configuration area ID of the network device to which the first cell belongs based on the wake-up signal configuration area ID included in the wake-up signal. As an example, the user equipment can also determine whether the wake-up signal configuration area ID of the network device to which the new cell belongs is the same as that of the original cell based on whether the broadcast signal (such as the wake-up signal) is the same.

In this case, even if the UE moves between cells, the main receiver of the UE is still in a dormant state.

In one embodiment, after the first transceiver is waked up, the second transceiver is turned off, and the power consumption for the second transceiver to remain in the on state can be reduced by turning off the second transceiver. In other embodiments, the second transceiver may have very low power consumption itself, and in order to reduce the switching between the on and off states of the second transceiver, the waked up state of the second transceiver can be maintained even if the first transceiver is waked up.

If the area ID carried by the monitored wake-up signal changes or the UE does receive any wake-up signal for a certain period, that is, the UE does not detect the wake-up signal configuration area ID in the original area, this indicates that the UE has entered a new area, which may be different from the wake-up signal configuration of the original area, such as moving from one cell to another. Then the previously received WUS configuration information may be not applicable, and the UE needs to turn on the main receiver to receive the WUS configuration information.

In the disclosed embodiment, the same LP WUS configuration is configured for multiple cells. In this way, when the UE moves from one cell to another within the multiple cells, as long as the wake-up signal configuration area ID of the new cell is the same as the wake-up signal configuration area ID of the cell before the move, the UE can still continue to use the LP receiver to receive the LP WUS signal, without turning on the main receiver to receive the system message to obtain the WUS configuration information of the new cell. This allows the UE to save more power.

FIG. 6 is a flow chart of a method for receiving wake-up signal configuration information according to an exemplary embodiment. As shown in FIG. 6, the method for receiving wake-up signal configuration information according to an exemplary embodiment of the present disclosure may be applied to a user equipment, and specifically includes the following processing steps:

Step 601: the UE receives a wake-up signal configuration from a network device.

In the embodiment of the present disclosure, the UE receives the wake-up signal configuration of the network device through the system message and/or the broadcast signal. Specifically, the wake-up signal configuration includes at least one of the following: the wake-up signal WUS cycle, the time domain offset, the number of WUS occasions in a WUS cycle, the time domain position distribution of each WUS occasion in a cycle, the frequency domain position of WUS, and the WUS sequence corresponding to the UE group.

In the embodiment, the number of WUS occasions in a WUS cycle is linearly related to the size of the WUS cycle. Specifically, the number of WUS occasions in a WUS cycle is configured as N=X×T, where T is the size of the WUS cycle, for example, the cycle T is in units of radio frames. T is 128, 256, etc.; X is a linearly related parameter, and X is less than or equal to 1. As an example, X is 1, 0.5, 0.25, 0.2, 0.125, etc.

It should be understood that the network device sends a wake-up signal configuration to the user device through broadcasting or other means, the user device receives the wake-up signal configuration through the main receiver, and in the case that the main receiver enters a dormant state, the wake-up signal configuration is used to use the LP receiver to monitor the wake-up signal.

FIG. 7 is a schematic diagram of a composition structure of an apparatus for configuring wake-up signal configuration information according to an exemplary embodiment. As shown in FIG. 7, the apparatus for configuring wake-up signal configuration information according to an embodiment of the present disclosure is applied to a network device, and the apparatus includes:
a configuration unit 70, configured to configure a wake-up signal configuration area ID; wherein wake-up signal configurations configured by the network devices having the same wake-up signal configuration area ID are the same.

On the basis of the apparatus for configuring the wake-up signal configuration area shown in FIG. 7, the apparatus for configuring the wake-up signal configuration area in an embodiment of the present disclosure further includes;
a first sending unit (not shown in FIG. 7), configured to send the wake-up signal configuration area ID to a UE.

In some exemplary embodiments, the sending unit is further configured to broadcast the wake-up signal configuration area ID through a system message.

In some exemplary embodiments, the wake-up signal configuration includes at least one of:
a wake-up signal WUS cycle, a time domain offset, a number of WUS occasions in one WUS cycle, a time domain position distribution of each WUS occasion in a cycle, a frequency domain position of the WUS, and a WUS sequence corresponding to a UE group.

In some exemplary embodiments, the number of WUS occasions in one WUS cycle is linearly related to the size of the WUS cycle.

In some exemplary embodiments, the number of WUS occasions in one WUS cycle being linearly related to the size of the WUS cycle, including:
the number of WUS occasions in one WUS cycle being configured as N=X×T. where T is the size of the WUS cycle, X is a linear correlation parameter, and X is less than or equal to 1.

On the basis of the apparatus for configuring the wake-up signal configuration area shown in FIG. 7, the apparatus for configuring the wake-up signal configuration area in an embodiment of the present disclosure further includes:
a second sending unit (not shown in FIG. 7), configured to send the wake-up signal configuration to the UE.

In an exemplary embodiment, the configuration unit 70, the first sending unit, the second sending unit, etc. can be implemented by one or more central processing units (CPU), graphics processing units (GPU), baseband processors (BP), application-specific integrated circuits (ASIC), digital signal processors (DSP), programmable logic devices (PLD), complex programmable logic devices (CPLD), field programmable gate arrays (FPGA), general-purpose processors, controllers, microcontrollers (MCU), microprocessors, or other electronic components, and can also be implemented in combination with one or more radio frequency (RF) antennas to perform the steps of the method for receiving wake-up signal configuration information in the aforementioned embodiment.

In the embodiments of the present disclosure, the specific manner in which each unit in the apparatus for configuring the wake-up signal configuration information shown in FIG. 7 performs operations has been described in detail in the embodiment of the method, and will not be elaborated on here.

FIG. 8 is a schematic diagram of a composition structure of an apparatus for receiving wake-up signal configuration information according to an exemplary embodiment. As shown in FIG. 8, the apparatus for receiving wake-up signal configuration information in an embodiment of the present disclosure is applied to a UE, and the apparatus includes:

a receiving unit 80, configured to receive a wake-up signal configuration area ID of a network device; wherein wake-up signal configurations configured by network devices having the same wake-up signal configuration area ID are the same.

The receiving unit 80 is further configured to obtain the wake-up signal configuration by monitoring the system message of the network device and/or receive the wake-up signal configuration area ID.

In some exemplary embodiments, the apparatus further includes:
a processing unit (not shown in FIG. 8), configured to determine, when a main receiver of a user equipment is in a dormant state and the user equipment moves from a first cell of a first network device to a second cell of a second network device, whether a received second wake-up signal configuration area ID sent by a second network device to which the second cell belongs is the same as a first wake-up signal configuration area ID sent by a first network device to which the first cell belongs, wherein:
when the first wake-up signal configuration area ID is the same as the second wake-up signal configuration area ID, maintaining the wake-up signal configuration of the first cell; and
when the first wake-up signal configuration area ID is different from the second wake-up signal configuration area ID, waking up the main receiver to receive the system message of the network device and obtain the wake-up signal configuration of the second cell.

In an exemplary embodiment, the receiving unit 80 and the processing unit may be implemented by one or more central processing units (CPU), graphics processing units (GPU), baseband processors (BP), application-specific integrated circuits (ASIC), digital signal processors (DSP), programmable logic devices (PLD), complex programmable logic devices (CPLD), field programmable gate arrays (FPGA), general-purpose processors, controllers, microcontrollers (MCU), microprocessors, or other electronic components, and may also be implemented in combination with one or more radio frequency (RF) antennas to execute the steps of the method for receiving wake-up signal configuration information of the aforementioned embodiment.

In the embodiments of the present disclosure, the specific manner in which each unit in the apparatus for receiving the wake-up signal configuration information shown in FIG. 8 performs operations has been described in detail in the embodiment of the method, and will not be elaborated on here.

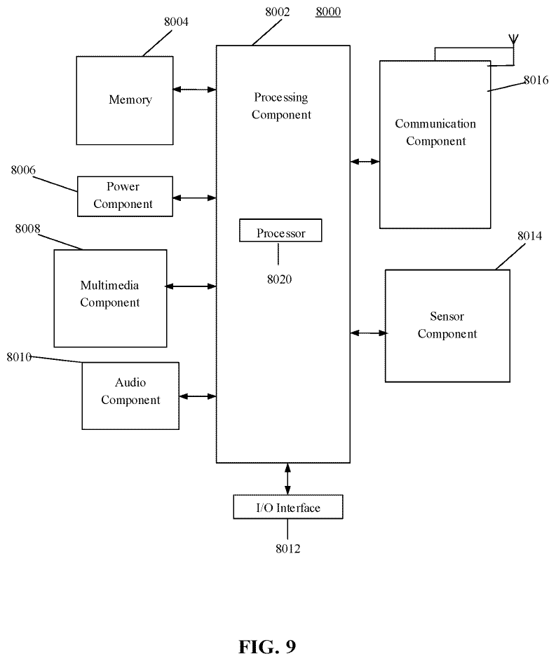

FIG. 9 is a block diagram of a user device 8000 according to an exemplary embodiment. For example, the user device 8000 may be a mobile phone, a computer, a digital broadcast terminal, a messaging device, a game console, a tablet device, a medical device, a fitness device, a personal digital assistant, etc.

Referring to FIG. 9, the user device 8000 may include one or more of the following components: a processing component 8002, a memory 8004, a power component 8006, a multimedia component 8008, an audio component 8010, an input/output (I/O) interface 8012, a sensor component 8014, and a communication component 8016.

The processing component 8002 generally controls the overall operations of the user equipment 8000, such as operations associated with display, telephone calls, data communications, camera operations, and recording operations. The processing component 8002 may include one or more processors 8020 to execute instructions to complete all or part of the steps of the above method. Additionally, processing component 8002 may include one or more modules that facilitate interaction between processing component 8002 and other components. For example, processing component 8002 may include a multimedia module to facilitate interaction between multimedia component 8008 and processing component 8002.

The memory 8004 is configured to store various types of data to support operations at the device 8000. Examples of such data include instructions for any application or method operating on the user equipment 8000, contact data, phonebook data, messages, pictures, videos, etc. The memory 8004 can be realized by any type of volatile or non-volatile storage device or their combination, such as static random access memory (SRAM), electrically erasable programmable read only memory (EEPROM), erasable programmable read only memory (EPROM), programmable read only memory (PROM), read only memory (ROM), magnetic memory, flash memory, magnetic disk or optical disk.

The power supply component 8006 provides power to various components of the user equipment 8000. The power component 8006 may include a power management system, one or more power supplies, and other components associated with generating, managing, and distributing power for user equipment 8000.

The multimedia component 8008 includes a screen providing an output interface between the user equipment 8000 and the user. In some embodiments, the screen may include a liquid crystal display (LCD) and a touch panel (TP). If the screen includes a touch pane, the screen may be implemented as a touch screen to receive input signals from a user. The touch panel includes one or more touch sensors to sense touches, swipes, and gestures on the touch panel. The touch sensor may not only sense a boundary of a touch or a swipe action, but also detect duration and pressure associated with the touch or swipe operation. In some embodiments, the multimedia component 8008 includes a front camera and/or a rear camera. When the device 8000 is in an operation mode, such as a photographing mode or a video mode, the front camera and/or the rear camera can receive external multimedia data. Each front camera and rear camera can be a fixed optical lens system or have focal length and optical zoom capability.

The audio component 8010 is configured to output and/or input audio signals. For example, the audio component 8010 includes a microphone (MIC), which is configured to receive an external audio signal when the user equipment 8000 is in an operation mode, such as a call mode, a recording mode and a voice recognition mode. Received audio signals may be further stored in memory 8004 or sent via communication component 8016. In some embodiments, the audio component 8010 also includes a speaker for outputting audio signals.

The VO interface 8012 provides an interface between the processing component 8002 and a peripheral interface module, which may be a keyboard, a click wheel, a button, and the like. These buttons may include, but are not limited to: a home button, volume buttons, start button, and lock button.

The sensor component 8014 includes one or more sensors for providing user equipment 8000 with various aspects of status assessment. For example, the sensor component 8014 can detect the open/closed state of the device 8000, the relative positioning of components, such as the display and the keypad of the user equipment 8000, the sensor component 8014 can also detect the user equipment 8000 or a change in the position of a component in the user equipment 8000, the presence or absence of user's contact with the user equipment 8000, the change of orientation or acceleration/deceleration of the user equipment 8000 and the temperature change of the user equipment 8000. The sensor component 8014 may include a proximity sensor configured to detect the presence of nearby objects in the absence of any physical contact. The sensor component 8014 may also include an optical sensor, such as a CMOS or CCD image sensor, for use in imaging applications. In some embodiments, the sensor component 8014 may also include an acceleration sensor, a gyroscope sensor, a magnetic sensor, a pressure sensor or a temperature sensor.

The communication component 8016 is configured to facilitate wired or wireless communication between the user equipment 8000 and other devices. The user equipment 8000 can access a wireless network based on communication standards, such as Wi-Fi, 2G or 3G, or a combination thereof In an exemplary embodiment, the communication component 8016 receives broadcast signals or broadcast related information from an external broadcast management system via a broadcast channel. In an exemplary embodiment, the communication component 8016 also includes a near field communication (NFC) module to facilitate short-range communication. For example, the NFC module can be implemented based on radio frequency identification (RFID) technology, infrared data association (IrDA) technology, ultra wideband (UWB) technology, bluetooth (BT) technology and other technologies.

In an exemplary embodiment, user equipment 8000 may be implemented by one or more application specific integrated circuits (ASIC), digital signal processors (DSP), digital signal processing devices (DSPD), programmable logic devices (PLD), field programmable gate array (FPGA), controllers, microcontrollers, microprocessors or other electronic components for performing the steps of the method described above.

In an exemplary embodiment, there is also provided a non-transitory computer-readable storage medium including instructions, such as the memory 8004 including instructions, which can be executed by the processor 8020 of the user equipment 8000 to implement the steps of the above method for configuring the wake-up signal configuration area. For example, the non-transitory computer readable storage medium may be ROM, random access memory (RAM), CD-ROM, magnetic tape, floppy disk, and optical data storage device, and the like.

An embodiment of the present disclosure also records a terminal, including a processor, a transceiver, a memory, and an executable program stored in the memory and capable of being run by the processor, wherein the processor executes the steps of the method for receiving wake-up signal configuration information of the aforementioned embodiment when running the executable program.

The embodiment of the present disclosure also records a network device. including a processor, a memory, and an executable program stored in the memory and capable of being run by the processor, and the processor executes the steps of the method for configuring wake-up signal configuration information when running the executable program.

The embodiment of the present disclosure further records a storage medium on which an executable program is stored. The executable program is executed by a processor to perform the steps of the method for configuring wake-up signal configuration information or the method for receiving wake-up signal configuration information of the aforementioned embodiment.

According to a first aspect of the present disclosure, a method for configuring wake-up signal configuration information is provided, which is applied to a network device, and the method includes:
configuring a wake-up signal configuration area identifier ID, wherein network devices having the same wake-up signal configuration area ID have the same wake-up signal configuration.

In some exemplary embodiments, the method further includes:
sending the wake-up signal configuration area ID to a user equipment UE.

In some exemplary embodiments, the sending the wake-up signal configuration area ID to the UE includes:
sending the wake-up signal configuration area ID through a system message and/or a wake-up signal WUS.

In some exemplary embodiments, the wake-up signal configuration includes at least one of:
a wake-up signal cycle;
a frequency domain location of the wake-up signal;
a time domain offset of the wake-up signal relative to a reference time;
a number of wake-up signal occasions in one wake-up signal cycle; a time domain position distribution of the wake-up signal occasions in one wake- up signal cycle; and
a wake-up signal sequence corresponding to a UE group.

In some exemplary embodiments, the number of WUS occasions in one WUS cycle is linearly related to a size of the WUS cycle.

In some exemplary embodiments, the number of WUS occasions in one WUS cycle is linearly related to the size of the WUS cycle, including:

the number of WUS occasions in one WUS cycle is N=X×T, wherein Tis the size of the WUS cycle, X is a linear correlation parameter, and X is less than or equal to 1.

In some exemplary embodiments, the method further includes:
sending the wake-up signal configuration a user equipment.

According to a second aspect of the present disclosure, a method for receiving wake-up signal configuration information is provided, which is applied to a user equipment, wherein the method includes:
receiving a wake-up signal configuration area identifier ID sent from a network
device, wherein network devices having the same wake-up signal configuration area ID have the same wake-up signal configuration.

In some exemplary embodiments, the method further includes:
receiving the wake-up signal configuration area ID sent from the network device through a system message and/or a wake-up signal.

In some exemplary embodiments, the method further includes:
in a case that a main receiver of the user equipment is in a dormant state and the user equipment is moved from a first cell of a first network device to a second cell of a second network device, judging whether a received second wake-up signal configuration area ID sent by the second network device to which the second cell belongs is the same as a first wake-up signal configuration area ID sent by the first network device to which the first cell belongs, wherein:
in a case that the first wake-up signal configuration area ID is the same as the second wake-up signal configuration area ID, maintaining the wake-up signal configuration of the first cell; and
in a case that the first wake-up signal configuration area ID is different from the second wake-up signal configuration area ID, waking up the main receiver to receive a system message of the second network device, to obtain the wake-up signal configuration of the second cell.

In some exemplary embodiments, the method further includes:
receiving the wake-up signal configuration sent by the network device.

According to a third aspect of the present disclosure, an apparatus for configuring wake-up signal configuration information is provided, which is applied to a network device, wherein the apparatus includes:
a configuring unit, configured to configure a wake-up signal configuration area identifier ID, wherein network devices having the same wake-up signal configuration area ID have the same wake-up signal configuration.

According to a fourth aspect of the present disclosure, a network device is provided, which includes a processor, a memory, and an executable program stored in the memory and capable of being run by the processor, wherein the processor is configured to execute steps of the method for configuring wake-up signal configuration information according to the first aspect when running the executable program.

According to a fifth aspect of the present disclosure, a user equipment is provided, which includes a processor, a memory and an executable program stored in the memory and capable of being run by the processor, wherein the processor is configured to execute steps of the method for receiving wake-up signal configuration information according to the second aspect when running the executable program.

According to a sixth aspect of the present disclosure, a storage medium having an executable program stored thereon is provided, wherein when the executable program is executed by a processor, steps of the method for configuring wake-up signal configuration information according to the first or second aspect are implemented.

According to the implementations of the embodiment of the present disclosure, the network device identifies the wake-up signal configuration area and notifies the UE of the wake-up signal configuration area ID. In this way, when the UE moves between cells, it can determine whether to use the wake-up signal configuration of the cell where it resides before moving, based on whether the wake-up signal configuration area ID of the network device to which the cell belongs is the same, without having to monitor the wake-up signal configuration of the new mobile cell. By configuring the wake-up signal configuration area ID, the embodiment of the present disclosure can enable that after the UE whose main receiver is in a dormant state moves across cells, and determines that the wake-up signal configuration information is the same based on the wake-up signal configuration area ID, it is not necessary to turn on the main receiver to monitor the system message to re-determine the wake-up signal configuration, thereby saving more power for the user equipment.

Other embodiments of the invention will be readily apparent to those skilled in the art from consideration of the specification and practice of the embodiment of the invention disclosed herein. This application is intended to cover any modification, use or adaptation of the embodiment of the present invention, these modifications, uses or adaptations follow the general principles of the embodiment of the present invention and include common knowledge or conventional technical means in the technical field not disclosed in the embodiment of this disclosure. The specification and examples are to be considered exemplary only, with a true scope and spirit of the embodiment of the invention being indicated by the following claims.

It should be understood that the embodiment of the present invention is not limited to the precise constructions which have been described above and shown in the accompanying drawings, and various modifications and changes may be made without departing from the scope thereof. The scope of the embodiment of the invention is limited only by the appended claims.

1. A method for configuring wake-up signal configuration information, applied to a network device, the method comprising:
configuring a wake-up signal configuration area identifier ID, wherein network devices having a same wake-up signal configuration area ID have a same wake-up signal configuration.

2. The method according to claim 1, further comprising:
sending the wake-up signal configuration area ID to a user equipment UE.

3. The method according to claim 2, wherein the sending the wake-up signal configuration area ID to the UE comprises:
sending the wake-up signal configuration area ID through a system message and/or a wake-up signal WUS.

4. The method according to claim 1,
wherein the wake-up signal configuration comprises at least one of:
a wake-up signal cycle;
a frequency domain location of the wake-up signal;
a time domain offset of the wake-up signal relative to a reference time;
a number of wake-up signal occasions in one wake-up signal cycle;
a time domain position distribution of the wake-up signal occasions in one wake-up signal cycle; and
a wake-up signal sequence corresponding to a UE group.

5. The method according to claim 4, wherein the number of WUS occasions in one WUS cycle is linearly related to a size of the WUS cycle.

6. The method according to claim 5, wherein the number of WUS occasions in one WUS cycle is linearly related to the size of the WUS cycle, comprising:
the number of WUS occasions in one WUS cycle is N=X×T, wherein T is the size of the WUS cycle, X is a linear correlation parameter, and X is less than or equal to 1.

7. The method according to claim 1, further comprising:
sending the wake-up signal configuration a user equipment.

8. A method for receiving wake-up signal configuration information, applied to a user equipment, the method comprising:
receiving a wake-up signal configuration area identifier ID sent from a network device, wherein network devices having a same wake-up signal configuration area ID have a same wake-up signal configuration.

9. The method according to claim 8, further comprising:
receiving the wake-up signal configuration area ID sent from the network device through a system message and/or a wake-up signal.

10. The method according to claim 8, further comprising:
in a case that a main receiver of the user equipment is in a dormant state and the user equipment is moved from a first cell of a first network device to a second cell of a second network device, judging whether a received second wake-up signal configuration area ID sent by the second network device to which the second cell belongs is a same as a first wake-up signal configuration area ID sent by the first network device to which the first cell belongs, wherein:
in a case that the first wake-up signal configuration area ID is the same as the second wake-up signal configuration area ID, maintaining the wake-up signal configuration of the first cell; and
in a case that the first wake-up signal configuration area ID is different from the second wake-up signal configuration area ID, waking up the main receiver to receive a system message of the second network device, to obtain the wake-up signal configuration of the second cell.

11. The method according to claim 8, further comprising:
receiving the wake-up signal configuration sent by the network device.

12. (canceled)

13. A network device, comprising:
a processor; and
a memory storing instructions executable by the processor,
wherein the processor is configured to execute a method for configuring wake-up signal configuration information, applied to a network device, the method comprising:
configuring a wake-up signal configuration area identifier ID, wherein network devices having a same wake-up signal configuration area ID have a same wake-up signal configuration.

14. A user equipment, comprising a processor, a memory and an executable program stored in the memory and capable of being run by the processor, wherein the processor is configured to execute steps of the method for receiving wake-up signal configuration information according to claim 8 when running the executable program.

15. A storage medium having an executable program stored thereon, wherein when the executable program is executed by a processor, steps of the method for configuring wake-up signal configuration information according to claim 1 implemented.

16. A storage medium having an executable program stored thereon, wherein when the executable program is executed by a processor, steps of the method for receiving wake-up signal configuration information according to claim 8 are implemented.

17. The network device according to claim 13, further comprising:
sending the wake-up signal configuration area ID to a user equipment UE.

18. The network device according to claim 17, wherein the sending the wake-up signal configuration area ID to the UE comprises:
sending the wake-up signal configuration area ID through a system message and/or a wake-up signal WUS.

19. The network device according to claim 13, wherein the wake-up signal configuration comprises at least one of:
a wake-up signal cycle;
a frequency domain location of the wake-up signal;
a time domain offset of the wake-up signal relative to a reference time;
a number of wake-up signal occasions in one wake-up signal cycle;
a time domain position distribution of the wake-up signal occasions in one wake-up signal cycle; and
a wake-up signal sequence corresponding to a UE group.

20. The network device according to claim 19, wherein the number of WUS occasions in one WUS cycle is linearly related to a size of the WUS cycle.

21. The network device according to claim 20, wherein the number of WUS occasions in one WUS cycle is linearly related to the size of the WUS cycle, comprising:
the number of WUS occasions in one WUS cycle is N=X×T, wherein T is the size of the WUS cycle, X is a linear correlation parameter, and X is less than or equal to 1.
